(19) United States
(12) Patent Application Publication
(10) Pub. No.: US 2017/0185831 A1
(43) Pub. Date: Jun. 29, 2017

(54) METHOD AND DEVICE FOR DISTINGUISHING FINGER AND WRIST

(71) Applicants: Le Holdings (Beijing) Co., Ltd., Beijing (CN); Le Shi Zhi Xin Electronic Technology (Tianjin) Limited, Tianjin (CN)

(72) Inventor: Yanjie Li, Binhai New Area (CN)

(21) Appl. No.: 15/241,353

(22) Filed: Aug. 19, 2016

Related U.S. Application Data
(63) Continuation of application No. PCT/CN2016/089576, filed on Jul. 10, 2016.

(30) Foreign Application Priority Data
Dec. 27, 2015 (CN) 201511007486.2

(51) Int. Cl. G06K 9/00; G06K 9/52; G06K 9/62

(52) U.S. Cl. CPC G06K 9/00355; G06K 9/6267; G06K 9/52; G06K 9/6201; G06K 2009/4666

(57) ABSTRACT

The present disclosure relates to the technical field of gesture recognition, and a method and apparatus for distinguishing between fingers and a wrist are disclosed. In some embodiments of the present disclosure, the following steps are included: acquiring a hand image, where the hand image includes fingers, a wrist, and an arm; calculating a dividing line that passes through a palm center location of the hand image and is perpendicular to a main axis of the hand image; acquiring respective relationships, between an area and a circumference, of two image areas formed by dividing the hand image by using the dividing line; and determining the image areas in which the fingers and the wrist are respectively located, according to the relationships between the area and the circumference. The fingers and the wrist are distinguished on the basis of circumference and area features of a connected area of a hand, so as to effectively eliminate interference with finger tip location by a wrist, thereby acquiring an image area of fingers simply, precisely, and quickly.

### CROSS-REFERENCE TO RELATED APPLICATIONS

The application is a continuation of PCT application No. PCT/CN2016/089576 submitted on Jul. 10, 2016, and the present disclosure claims priority to Chinese Patent Application No. 201511007486.2, filed with the Chinese Patent Office on Dec. 27, 2015 and entitled “METHOD FOR DISTINGUISHING BETWEEN FINGERS AND WRIST AND ELECTRONIC DEVICE”, which is incorporated herein by reference in its entirety.

### TECHNICAL FIELD

The present disclosure relates to the field of gesture recognition technologies, and in particular, to a method for distinguishing between fingers and a wrist and an electronic device.

### BACKGROUND

Gesture recognition is a process of recognizing human gestures by using a series of algorithms, and needed hand information is collected in a man-machine interaction manner. A key technology of the gesture recognition is to locate of a palm and each finger tip, and an existing gesture recognition technology is mainly to detect fingers and a wrist by using raised and sunk features of contours.

The inventor finds during a process of implementing this application that a hand transforms greatly, and fingers and a wrist may have similar contour features. Therefore, a process of locating finger tips is often interfered by a wrist, and a misjudgment of fingers and the wrist occurs, thereby causing problems such as low precision and poor accuracy.

### SUMMARY

This application provides a method for distinguishing between fingers and a wrist and an electronic device, so as to effectively eliminate interference with finger tip location by a wrist, thereby acquiring an image area of fingers simply, precisely, and quickly.

According to the first aspect, an embodiment of the present disclosure provides a method and apparatus for distinguishing between fingers and a wrist, including: acquiring a hand image, where the hand image includes fingers, a wrist, and an arm; calculating a dividing line that passes through a palm center location of the hand image and is perpendicular to a main axis of the hand image; acquiring respective relationships, between an area and a circumference, of two image areas formed by dividing the hand image by using the dividing line; and determining the image areas in which the fingers and the wrist are respectively located, according to the relationships between the area and the circumference.

According to the second aspect, an embodiment of the present disclosure further provides a non-volatile computer storage medium, which stores a computer executable instruction, where the computer executable instruction is used to execute any foregoing method for distinguishing between fingers and a wrist of this application.

According to the third aspect, an embodiment of the present disclosure further provides an electronic device, including: at least one processor; and a memory for storing instructions executable by the at least one processor, where execution of the instructions by the at least one processor causes the at least one processor to execute any foregoing method for distinguishing between fingers and a wrist of this application.

According to embodiments of the present disclosure compared with the prior art, a dividing line that passes through a palm center location of a hand image and is perpendicular to a main axis is obtained through calculation, and the hand image is divided into two image areas by using the dividing line. From the perspective of features of fingers and a wrist, the fingers are slenderer than the wrist, the wrist is closer to a circle than the fingers, and a sum of contour circumferences of the fingers is greater than a contour circumference of the wrist, while areas of the two do not differ a lot. For figures having a same area, a circumference of a circle is minimal. Therefore, circumference and area features of a connected area of a hand may be used to distinguish between the fingers and the wrist, so as to effectively eliminate interference with finger tip location by the wrist, thereby acquiring an image area of fingers simply, precisely, and quickly.

In an embodiment, the relationship between the area and the circumference is a ratio of the square of the circumference to the area; the step that determining the image areas in which the fingers and the wrist are respectively located, according to the relationships between the area and the square of the circumference includes: comparing respective ratios, of the two image areas, of the square of the circumference to the area; and using an image area corresponding to a greater ratio as the image area in which the fingers are located, and using an image area corresponding to a less ratio as the image area in which the wrist is located. The ratio of the square of the circumference to the area is used as a determining indicator, so as to determine the fingers and the palm more precisely. Obvious distinction features (contour circumferences) of the fingers the wrist are amplified by using an algorithm of the square of the circumference, so that the ratios of the square of the circumference to the area have an obvious difference, which effectively eliminates interference with finger tip location by a wrist, thereby obtaining the image area in which the fingers are located more quickly and more accurately.

In an embodiment, a step that acquiring intersecting points of the dividing line and the hand image includes: detecting an angle of the dividing line and a horizontal line; and if the angle is less than 45 degrees, acquiring coordinates of the intersecting points of the dividing line and the hand image according to the following formula:

$$\{ \begin{matrix}{x}_{1} = 0 \\ {y}_{1} = - ( {A}_{v} * {x}_{1} + {C}_{v} ) / {B}_{v}\end{matrix} \\ \{ \begin{matrix}{x}_{2} = w - 1 \\ {y}_{2} = - ( {A}_{v} * {x}_{2} + {C}_{v} ) / {B}_{v}\end{matrix}$$

if the angle is greater than or equal to 45 degrees, acquiring coordinates of the intersecting points of the dividing line and the hand image according to the following formula:

$$\{ \begin{matrix}{y}_{1} = 0 \\ {x}_{1} = - ( {B}_{v} * {y}_{1} + {C}_{v} ) / {A}_{v}\end{matrix} \\ \{ \begin{matrix}{y}_{2} = h - 1 \\ {x}_{2} = - ( {B}_{v} * {y}_{2} + {C}_{v} ) / {A}_{v}\end{matrix}$$

where (x1, y1) and (x2, y2) are respectively the coordinates of the intersecting points, and w and h are respectively a width and a height of the hand image.

The angle of the dividing line and the horizontal line is detected when the intersecting points of the dividing line and the hand image are acquired, and the coordinates of the intersecting points are acquired by using different formulas according to whether the angle of the dividing line and the horizontal line is less than 45 degrees, so as to avoid a condition in which correct intersecting points cannot be obtained through calculation when the straight line is perpendicular to or parallel to the horizontal line.

In an embodiment, the step that acquiring a hand image includes: acquiring a skin pixel model and a non-skin pixel model in advance; traversing each pixel in an original image, and matching pixels obtained by traversing, and the skin pixel model and the non-skin pixel model that are acquired in advance; obtaining a skin area and a non-skin area by dividing according to match results; and performing connected-area detection on the skin area to obtain the hand image. Each pixel in the original image is matched with the skin pixel model and the non-skin pixel model that are acquired in advance, so as to distinguish between the skin area and the non-skin area simply and precisely, thereby quickly acquiring the hand image, and effectively simplifying a process of acquiring the hand image.

### BRIEF DESCRIPTION OF THE DRAWINGS

One or more embodiments are exemplarily described by using figures that are corresponding thereto in the accompanying drawings; the exemplary descriptions do not form a limitation to the embodiments. Elements with same reference signs in the accompanying drawings are similar elements. Unless otherwise particularly stated, the figures in the accompanying drawings do not form a scale limitation.

FIG. 1 is a flowchart of a method for distinguishing between fingers and a wrist according to the first implementation manner of the present disclosure;

FIG. 2 is a diagram of a connected area of a hand according to the first implementation manner of the present disclosure;

FIG. 3 is a diagram of a palm center position in the connected area of the hand according to the first implementation manner of the present disclosure;

FIG. 4 is a diagram of a position of a main axis in the connected area of the hand according to the first implementation manner of the present disclosure;

FIG. 5 is a diagram of a dividing line of fingers and a wrist according to the first implementation manner of the present disclosure;

FIG. 6 is a schematic structural diagram of an apparatus for distinguishing between fingers and a wrist according to the third implementation manner of the present disclosure; and

FIG. 7 is a schematic structural diagram of an electronic device according to the fifth implementation manner of the present disclosure.

### DETAILED DESCRIPTION

To make objectives, technical solutions, and advantages of the present disclosure clearer, the following describes each implementation manner of the present disclosure in detail with reference to the accompanying drawings. However, a person of ordinary skill in the art should understand that in each implementation manner of the present disclosure, many technical details are proposed in order to make readers understand the present disclosure better. However, even if there are not these technical details and various changes and modifications based on the following implementation manners, technical solutions that are claimed to be protected by each claim of the present disclosure may also be implemented.

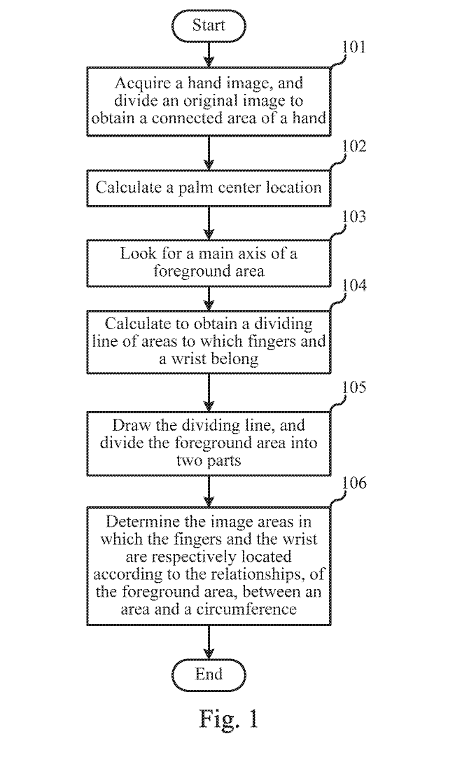

The first implementation manner of the present disclosure relates to a method for distinguishing between fingers and a wrist, and a specific process is shown in FIG. 1.

Step 101: Acquire a hand image. Specifically, an original image is divided to obtain a connected area of a hand (that is, the hand image), where the hand image includes fingers, a wrist, and an arm. In the step, a skin pixel model and a non-skin pixel model are acquired in advance; each pixel in the original image is traversed, and pixels obtained by traversing is matched with the skin pixel model and the non-skin pixel model that are acquired in advance; an skin area and an non-skin area are obtained by dividing according to match results; and connected-area detection is performed on the skin area to obtain the hand image. Each pixel in the original image is matched with the skin pixel model and the non-skin pixel model that are acquired in advance, so as to distinguish between the skin area and the non-skin area simply and precisely, thereby quickly acquiring the hand image.

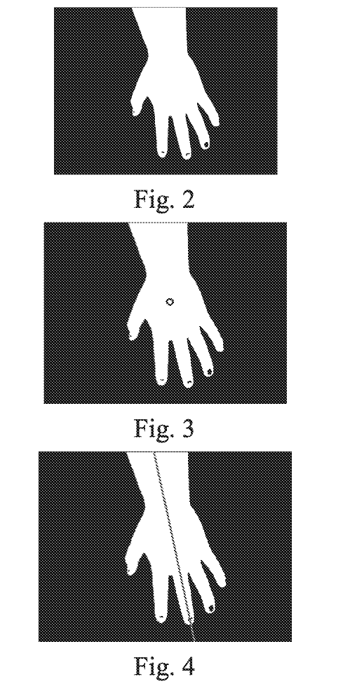

For example, the acquired hand image is transformed into a color model HSV or a color space YCrCb, then it is determined that each pixel in the image belongs to skin or non-skin according to a value range of skin colors, and a foreground obtained by dividing the original image is the connected area of the hand, as shown in FIG. 2.

Next, perform step 102: Calculate a palm center location. The palm center location may be determined according to contour features. For example, first, each pixel is traversed to obtain a distance of each pixel to all points of a contour; then, pixels whose distances to the contour are shortest are acquired, so as to obtain shortest distances of all pixels to the contour; at last, a pixel corresponding to a maximum distance among the obtained shortest distances is used as a palm center. The palm center location in the connected area of the hand is shown in FIG. 3.

Next, perform step 103: Look for a main axis of a foreground area.

Specifically, a method for looking for the main axis of the foreground area is: traversing all pixels of the hand image, and saving a coordinate of each obtained pixel in a matrix; and fitting each element in the matrix by using the least square method to obtain a straight line, where the straight line obtained by fitting is the main axis. In an actual operation, each element may be fitted by using an Open Source Computer Vision Library (OpenCV), more specifically, a function cvFitLine is called from the OpenCV, then each element in the matrix may be fitted to obtain the main axis. The cvFitLine is defined as follows:

CVAPI(void) cvFitLine(const CvArr*points, int dist_type, double param, double reps, double aeps, float*line);

where points is a matrix formed by foreground pixel coordinates, line is used to return a linear equation, dist_type is CV_DIST_L2, param is 0, and reps and aeps both are 0.01.

Because the linear equation returned by the cvFitLine is a direction vector of a straight line and a point on the straight line, the linear equation needs to be converted into a general equation of the straight line to be used, and a general parameter of the main axis is obtained by using the following conversion formula:

A=v₁

B=−v₂

C=v₁*y−v₂*x

where A, B, and C are the general parameters of the straight line, (v₁, v₂) is the direction vector of the straight line, and (x, y) is the point on the straight line. The location of the obtained main axis in the connected area of the hand is shown in FIG. 4.

Next, perform step 104: Calculate to obtain a dividing line of the areas to which the fingers and the wrist belong. A straight line that passes through the palm center location of the hand image and is perpendicular to the main axis of the hand image is calculated, and the straight line is the dividing line. A linear equation perpendicular to the main axis may be obtained according to the main axis equation and a coordinate of the palm center, that is, the dividing line of the areas to which the fingers and the wrist belong, and a calculation equation is shown as follows:

Aᵥ=B

Bᵥ=−A

Cᵥ=A*yₚ−B*xₚ

where A, B, and C are linear equation parameters of the main axis, Aᵥ, Bᵥ, and Cᵥ are linear equation parameters of the dividing line, and (xₚ, yₚ) is the coordinate of the palm center location.

Next, perform step 105: Draw the dividing line, and divide the foreground area into two parts. The dividing line drawn herein has a same color with a background, so that the foreground may be divided into two parts. When the dividing line is drawn, intersecting points of the dividing line and the hand image are obtained through calculation.

Coordinates of the intersecting points of the dividing line and the hand image are acquired according to the following formula:

$$\{ \begin{matrix}{x}_{1} = 0 \\ {y}_{1} = - ( {A}_{v} * {x}_{1} + {C}_{v} ) / {B}_{v}\end{matrix} \\ \{ \begin{matrix}{x}_{2} = w - 1 \\ {y}_{2} = - ( {A}_{v} * {x}_{2} + {C}_{v} ) / {B}_{v}\end{matrix}$$

where (x₁, y₁) and (x₂, y₂) are respectively the coordinates of the intersecting points, and w is a width of the hand image.

The two image areas formed by dividing the hand image by using the dividing line are obtained according to the acquired intersecting points and the dividing line. In an actual operation, it may be implemented by using the OpenCV. Specifically, a function cvLine is called from the OpenCV, the dividing line is drawn in the image, and the image is divided into two parts. The cvLine is defined as follows:

CVAPI(void) cvLine(CvArr*img,CvPoint pt1, CvPoint pt2,

CvScalar color, int thickness CV_DEFAULT(1),

int line_type CV_DEFAULT(8), int shift CV_DEFAULT(0));

where pt₁ and pt₂ are the intersecting points of the dividing line and the hand image.

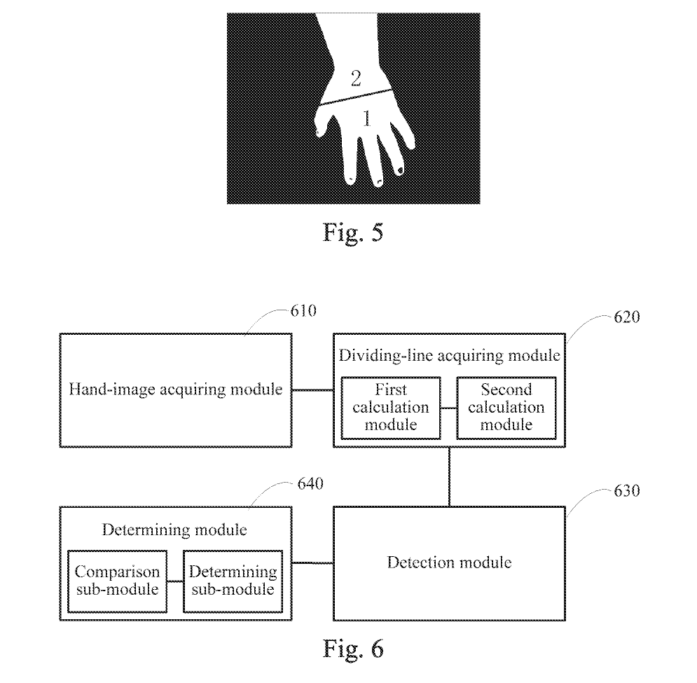

A drawing result of the dividing line of the fingers and the wrist is shown in FIG. 5.

Next, perform step 106: Determine the image areas in which the fingers and the wrist are respectively located according to relationships, of the foreground area, between an area and a circumference. In this implementation manner, the image areas in which the fingers and the wrist are respectively located are determined according to the relationships of the area and the square of the circumference.

Specifically, after the drawn dividing line is obtained, the hand image is divided into two areas: an area 1 and an area 2, as shown in FIG. 5. In the step, a ratio T1, of the area 1, of the square of the circumference to the area is calculated, and a ratio T2, of the area 2, of the square of the circumference to the area is calculated. A unit of measurement herein is a pixel, and a length of one pixel is 1. By using the pixel as the unit of measurement, and using the ratio of the square of the circumference to the area as a feature value, the obtained feature value is not related to the length unit, so as to effectively avoid impacts on a calculation result due to different length units. The respective ratios, (that is, T1 and T2), of the two image areas, of the square of the circumference to the area are compared; an image area corresponding a greater ratio is used as the image area in which the fingers are located, and an image area corresponding a less ratio is used as the image area in which the wrist is located. For example, if T1 is greater than T2, it is indicated that the area 1 is the image area in which the fingers are located, and the area 2 is the image area in which the wrist is located.

An example in which the step is implemented in the OpenCV is used to provide descriptions. First, a function cvFindContours of the OpenCV is used to implement a function of looking for the connected area, and the cvFindContours is defined as follows:

int cvFindContours(CvArr*image,CvMemStorage*storage,CvSeq**firstContour,int headerSize=sizeof(CvContour),int mode=CV_RETR_LIST, intmethod=CV_CHAIN_APPROX_SIMPLE, CvPoint offset=cvPoint(0,0))

Secondly, after the connected area is obtained through detection, functions cvContourArea and cvArcLength may be respectively called to calculate to obtain the areas and the circumferences of contours, thereby obtaining ratios of the square of the circumference to the area.

At last, the image area in which the fingers are located is determined by comparing the ratios of the square of the circumference to the area. A greater ratio corresponds to the area in which the fingers are located, and a less ratio corresponds to the area in which the wrist is located. The ratio, of a connected area on the fingers side, of the square of the circumference to the area is greater than the ratio, of a connected area on the wrist side. Therefore, the image area in which the fingers are located may be determined by comparing the feature values. From the perspective of features of the fingers and the wrist, the fingers are slenderer than the wrist, the wrist is closer to a circle than the fingers, and a sum of contour circumferences of the fingers is greater than the contour circumference of the wrist, while the areas of the two do not differ a lot. For figures having a same area, a circumference of a circle is minimal. Therefore, circumference and area features of the connected area of the hand may be used to distinguish between the fingers and the wrist, so as to effectively eliminate interference with finger tip location by the wrist, thereby acquiring an image area of fingers simply, precisely, and quickly.

It should be noted that in this implementation manner, the ratio of the square of the circumference to the area is used as a determining indictor to determine the fingers and the palm more precisely. Obvious distinction features (the contour circumferences) of the fingers and the wrist are amplified, so that the ratios of the square of the circumference to the area have an obvious difference, thereby obtaining the image area in which the fingers are located more quickly and more accurately. However, in an actual application, other relationships (for example, any mathematic transformation of the ratio of the square of the circumference to the area) between the circumference and the area may be used, as detection basis of the image area in which the fingers are located, which is not described in detail herein.

The second implementation manner of the present disclosure relates to a method for distinguishing between fingers and a wrist. The second implementation manner performs further improvements on the basis of the first implementation manner, and the improvements are mainly that a step that acquiring the intersecting points of the dividing line and the hand image includes: detecting an angle of the dividing line and a horizontal line; and

if the angle is less than 45 degrees, acquiring the coordinates of the intersecting points of the dividing line and the hand image according to the following formula:

$$\{ \begin{matrix}{x}_{1} = 0 \\ {y}_{1} = - ( {A}_{v} * {x}_{1} + {C}_{v} ) / {B}_{v}\end{matrix} \\ \{ \begin{matrix}{x}_{2} = w - 1 \\ {y}_{2} = - ( {A}_{v} * {x}_{2} + {C}_{v} ) / {B}_{v}\end{matrix}$$

if the angle is greater than or equal to 45 degrees, acquiring the coordinates of the intersecting points of the dividing line and the hand image according to the following formula:

$$\{ \begin{matrix}{y}_{1} = 0 \\ {x}_{1} = - ( {B}_{v} * {y}_{1} + {C}_{v} ) / {A}_{v}\end{matrix} \\ \{ \begin{matrix}{y}_{2} = h - 1 \\ {x}_{2} = - ( {B}_{v} * {y}_{2} + {C}_{v} ) / {A}_{v}\end{matrix}$$

where (x₁, y₁) and (x₂, y₂) are respectively the coordinates of the intersecting points, and w and h are respectively a width and a height of the hand image.

The angle of the dividing line and the horizontal line is detected, a relationship between the angle and 45 degrees is determined, and the coordinates are calculated by using a corresponding formula according to a determining result, so as to avoid a condition in which correct intersecting points cannot be obtained through calculation when the dividing line is perpendicular to or parallel to the horizontal line. During a process of collecting the hand image, for collected gestures in any angles, intersecting points of a dividing line and a hand area may be acquired by using one of the foregoing different formulas, rather than calculating coordinates of the intersecting points by limiting the gesture to be in a particular angle.

The step divisions of the various methods above are only for clear descriptions and may be combined as one step, or some steps are disassembled into multiple steps during implementation, which all fall within the protection scope of the present disclosure only if the same logic relationships are included. Inessential modifications that are added in algorithms or processes or inessential designs that are brought in but not change a core design of the algorithms and the processes are all in the protection scope of the present disclosure.

The third implementation manner of the present disclosure relates to an apparatus for distinguishing between fingers and a wrist, as shown in FIG. 6, including: a hand-image acquiring module 610, configured to acquire a hand image, where the hand image includes fingers, a wrist, and an arm; a dividing-line acquiring module 620, configured to calculate a dividing line that passes through a palm center location of the hand image and is perpendicular to a main axis of the hand image; a detection module 630, configured to acquire respective relationships, between an area and a circumference, of two image areas formed by dividing the hand image by using the dividing line; and a determining module 640, configured to determine the image areas in which the fingers and the wrist are respectively located, according to the relationships between the area and the circumference.

Further, the relationship between the area and the circumference is a ratio of the square of the circumference to the area; and

a determining module 640 includes:

a comparison sub-module, configured to compare respective ratios, of the two image areas, of the square of the circumference to the area; and

a determining sub-module, configured to use an image area corresponding a greater ratio as the image area in which the fingers are located, and use an image area corresponding a less ratio as the image area in which the wrist is located.

Further, the dividing-line acquiring module 620 includes:

a first calculation sub-module, configured to calculate the palm center location of the hand image and the main axis of the hand image; and

a second calculation sub-module, configured to calculate the dividing line according to the following formula:

Aᵥ=B

Bᵥ=−A

Cᵥ=A*yₚ−B*xₚ

where A, B, and C are linear equation parameters of the main axis, Aᵥ, Bᵥ, and Cᵥ are linear equation parameters of the dividing line, and (xₚ, yₚ) is a coordinate of the palm center location.

It is not hard to found that this implementation manner is a systematic embodiment corresponding to the first implementation manner, and this implementation manner may be implemented by mutually cooperating with the first implementation manner. Related technical details mentioned in the first implementation manner are still effective in this implementation manner, and in order to reduce repetition, details are not described herein again. Correspondingly, related technical details mentioned in this implementation manner may also be applied to the first implementation manner.

The fourth implementation manner of the present disclosure relates to a non-volatile computer storage medium, which stores a computer executable instruction, where the computer executable instruction can execute the method for distinguishing between fingers and a wrist in any one of the foregoing method embodiments.

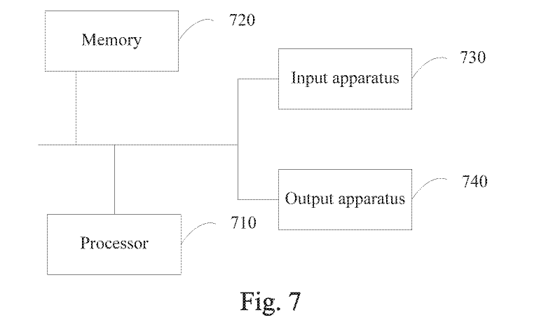

The fifth implementation manner of the present disclosure relates to an electronic device for executing a method for distinguishing between fingers and a wrist, a schematic structural diagram of hardware is shown in FIG. 7, and the device includes:

one or more processors 710 and a memory 720, where only one processor 710 is used as an example in FIG. 7.

The device for executing the method for distinguishing between fingers and a wrist may further include: an input apparatus 730 and an output apparatus 740.

The processor 710, the memory 720, the input apparatus 730, and the output apparatus 740 can be connected by means of a bus or in other manners. A connection by means of a bus is used as an example in FIG. 7.

As a non-volatile computer readable storage medium, the memory 720 can be used to store non-volatile software programs, non-volatile computer executable programs and modules, for example, a program instruction/module corresponding to the method for distinguishing between fingers and a wrist in the embodiments of this application (for example, the hand-image acquiring module 610, the dividing-line acquiring module, the detection module 630, and the determining module 640 shown in FIG. 6). The processor 710 executes various functional applications and data processing of a server, that is, implements the method for distinguishing between fingers and a wrist of the foregoing method embodiments, by running the non-volatile software programs, instructions, and modules that are stored in the memory 720.

The memory 720 may include a program storage area and a data storage area, where the program storage area may store an operating system and an application that is needed by at least one function; the data storage area may store data created for distinguishing between fingers and a wrist, and the like. In addition, the memory 720 may include a high-speed random access memory, or may also include a non-volatile memory such as at least one disk storage device, flash storage device, or another non-volatile solid-state storage device. In some embodiments, the memory 720 optionally includes memories that are remotely disposed with respect to the processor 710, and the remote memories may be connected, via a network, to an apparatus for distinguishing between fingers and a wrist. Examples of the foregoing network include but are not limited to: the Internet, an intranet, a local area network, a mobile communications network, or a combination thereof.

The input apparatus 730 can receive entered digits or character information, and generate key signal inputs relevant to user setting and functional control of the apparatus for distinguishing between fingers and a wrist. The output apparatus 740 may include a display device, for example, a display screen.

The one or more modules are stored in the memory 720; when the one or more modules are executed by the one or more processors 710, the method for distinguishing between fingers and a wrist in any one of the foregoing method embodiments is executed.

The foregoing product can execute the method provided in the embodiments of this application, and has corresponding functional modules for executing the method and beneficial effects. Refer to the method provided in the embodiments of this application for technical details that are not described in detail in this embodiment.

The electronic device in this embodiment of this application exists in multiple forms, including but not limited to:

Mobile communication device: such devices are characterized by having a mobile communication function, and primarily providing voice and data communications; terminals of this type include: a smart phone (for example, an iPhone), a multimedia mobile phone, a feature phone, a low-end mobile phone, and the like;

Ultra mobile personal computer device: such devices are essentially personal computers, which have computing and processing functions, and generally have the function of mobile Internet access; terminals of this type include: PDA, MID and UMPC devices, and the like, for example, an iPad;

Portable entertainment device: such devices can display and play multimedia content; devices of this type include: an audio and video player (for example, an iPod), a handheld game console, an e-book, an intelligent toy and a portable vehicle-mounted navigation device;

Server: a device that provides a computing service; a server includes a processor, a hard disk, a memory, a system bus, and the like; an architecture of a server is similar to a universal computer architecture. However, because a server needs to provide highly reliable services, requirements for the server are high in aspects of the processing capability, stability, reliability, security, extensibility, and manageability; and

Other electronic apparatuses having a data interaction function.

The apparatus embodiment described above is merely exemplary, and units described as separated components may be or may not be physically separated; components presented as units may be or may not be physical units, that is, the components may be located in a same place, or may be also distributed on multiple network units. Some or all modules therein may be selected according to an actual requirement to achieve the objective of the solution of this embodiment.

Through description of the foregoing implementation manners, a person skilled in the art can clearly learn that each implementation manner can be implemented by means of software in combination with a universal hardware platform, and certainly, can be also implemented by using hardware. Based on such understanding, the essence, or in other words, a part that makes contributions to relevant technologies, of the foregoing technical solutions can be embodied in the form of a software product. The computer software product may be stored in a computer readable storage medium, for example, a ROM/RAM, a magnetic disk, or a compact disc, including several instructions for enabling a computer device (which may be a personal computer, a sever, or a network device, and the like) to execute the method in the embodiments or in some parts of the embodiments.

Finally, it should be noted that: the foregoing embodiments are only used to describe the technical solutions of the present disclosure, rather than limit the present disclosure. Although this application is described in detail with reference to the foregoing embodiments, a person of ordinary skill in the art should understand that he/she can still modify technical solutions disclosed in the foregoing embodiments, or make equivalent replacements to some technical features therein; however, the modifications or replacements do not make the essence of corresponding technical solutions depart from the spirit and scope of the technical solutions of the embodiments of this application.

1. A method for distinguishing between fingers and a wrist, applied to an electronic device, comprising:
acquiring a hand image, wherein the hand image comprises fingers, a wrist, and an arm;
calculating a dividing line that passes through a palm center location of the hand image and is perpendicular to a main axis of the hand image;
acquiring respective relationships, between an area and a circumference, of two image areas formed by dividing the hand image by using the dividing line; and
determining the image areas in which the fingers and the wrist are respectively located, according to the relationships between the area and the circumference.

2. The method for distinguishing between fingers and a wrist according to claim 1, wherein the relationship between the area and the circumference is a ratio of the square of the circumference to the area; and
the determining the image areas in which the fingers and the wrist are respectively located, according to the relationships between the area and the circumference comprises:
comparing respective ratios, of the two image areas, of the square of the circumference to the area; and
using an image area corresponding to a greater ratio as an image area in which the fingers are located, and using an image area corresponding to a less ratio as an image area in which the wrist is located.

3. The method for distinguishing between fingers and a wrist according to claim 1, wherein the calculating a dividing line that passes through a palm center location of the hand image and is perpendicular to a main axis of the hand image comprises:
calculating the palm center location of the hand image and the main axis of the hand image; and
calculating the dividing line according to the following formula:
Aᵥ=B
Bᵥ=−A
Cᵥ=A*yₚ−B*xₚ
wherein A, B, and C are linear equation parameters of the main axis, Aᵥ, Bᵥ, and Cᵥ are linear equation parameters of the dividing line, and (xₚ, yₚ) is a coordinate of the palm center location.

4. The method for distinguishing between fingers and a wrist according to claim 1, wherein the acquiring respective relationships, between an area and a circumference, of two image areas formed by dividing the hand image by using the dividing line comprises:
acquiring intersecting points of the dividing line and the hand image; and
obtaining the two image areas formed by dividing the hand image by using the dividing line, according to the acquired intersecting points and the dividing line.

5. The method for distinguishing between fingers and a wrist according to claim 4, wherein the acquiring intersecting points of the dividing line and the hand image comprises:
detecting an angle of the dividing line and a horizontal line; and
if the angle is less than 45 degrees, acquiring coordinates of the intersecting points of the dividing line and the hand image according to the following formula:
$$\{ \begin{matrix}{x}_{1} = 0 \\ {y}_{1} = - ( {A}_{v} * {x}_{1} + {C}_{v} ) / {B}_{v}\end{matrix} \\ \{ \begin{matrix}{x}_{2} = w - 1 \\ {y}_{2} = - ( {A}_{v} * {x}_{2} + {C}_{v} ) / {B}_{v}\end{matrix}$$
if the angle is greater than or equal to 45 degrees, acquiring coordinates of the intersecting points of the dividing line and the hand image according to the following formula:
$$\{ \begin{matrix}{y}_{1} = 0 \\ {x}_{1} = - ( {B}_{v} * {y}_{1} + {C}_{v} ) / {A}_{v}\end{matrix} \\ \{ \begin{matrix}{y}_{2} = h - 1 \\ {x}_{2} = - ( {B}_{v} * {y}_{2} + {C}_{v} ) / {A}_{v}\end{matrix}$$
wherein (x₁, y₁) and (x₂, y₂) are respectively the coordinates of the intersecting points, and w and h are respectively a width and a height of the hand image.

6. The method for distinguishing between fingers and a wrist according to claim 3, wherein the calculating the main axis of the hand image comprises:
traversing all pixels of the hand image, and saving a coordinate of each obtained pixel in a matrix;
fitting each element in the matrix by using the least square method to obtain a straight line; and
using the straight line obtained by fitting as the main axis.

7. The method for distinguishing between fingers and a wrist according to claim 1, wherein the acquiring a hand image comprises:
acquiring a skin pixel model and a non-skin pixel model in advance;
traversing each pixel of an original image, and
matching pixels obtained by traversing and, the skin pixel model and the non-skin pixel model that are acquired in advance;
obtaining a skin area and a non-skin area by dividing according to match results; and
performing connected-area detection on the skin area to obtain the hand image.

8-11. (canceled)

12. A non-volatile computer storage medium, which stores computer executable instructions, that when executed by an electronic device, cause the electronic device to:
acquire a hand image, wherein the hand image comprises fingers, a wrist, and an arm;
calculate a dividing line that passes through a palm center location of the hand image and is perpendicular to a main axis of the hand image;
acquire respective relationships, between an area and a circumference, of two image areas formed by dividing the hand image by using the dividing line; and
determine the image areas in which the fingers and the wrist are respectively located, according to the relationships between the area and the circumference.

13. The non-volatile computer storage medium according to claim 12, wherein the relationship between the area and the circumference is a ratio of the square of the circumference to the area;
wherein the instructions to determine the image areas in which the fingers and the wrist are respectively located, according to the relationships between the area and the circumference cause the electronic device to:
compare respective ratios, of the two image areas, of the square of the circumference to the area; and
use an image area corresponding to a greater ratio as an image area in which the fingers are located, and use an image area corresponding to a less ratio as an image area in which the wrist is located.

14. The non-volatile computer storage medium according to claim 12, wherein the instructions to calculate a dividing line that passes through a palm center location of the hand image and is perpendicular to a main axis of the hand image cause the electronic device to:
calculate the palm center location of the hand image and the main axis of the hand image; and
calculate the dividing line according to the following formula:
Aᵥ=B
Bᵥ=−A
Cᵥ=A*yₚ−B*xₚ
wherein A, B, and C are linear equation parameters of the main axis, Aᵥ, Bᵥ, and Cᵥ are linear equation parameters of the dividing line, and (xₚ, yₚ) is a coordinate of the palm center location.

15. The non-volatile computer storage medium according to claim 12, wherein the instructions to acquire respective relationships, between an area and a circumference, of two image areas formed by dividing the hand image by using the dividing line cause the electronic device to:
acquire intersecting points of the dividing line and the hand image; and
obtain the two image areas formed by dividing the hand image by using the dividing line, according to the acquired intersecting points and the dividing line.

16. The non-volatile computer storage medium according to claim 15, wherein the instructions to acquire intersecting points of the dividing line and the hand image cause the electronic device to:
detect an angle of the dividing line and a horizontal line; and
if the angle is less than 45 degrees, acquire coordinates of the intersecting points of the dividing line and the hand image according to the following formula:
$$\{ \begin{matrix}{x}_{1} = 0 \\ {y}_{1} = - ( {A}_{v} * {x}_{1} + {C}_{v} ) / {B}_{v}\end{matrix} \\ \{ \begin{matrix}{x}_{2} = w - 1 \\ {y}_{2} = - ( {A}_{v} * {x}_{2} + {C}_{v} ) / {B}_{v}\end{matrix}$$
if the angle is greater than or equal to 45 degrees, acquiring coordinates of the intersecting points of the dividing line and the hand image according to the following formula:
$$\{ \begin{matrix}{y}_{1} = 0 \\ {x}_{1} = - ( {B}_{v} * {y}_{1} + {C}_{v} ) / {A}_{v}\end{matrix} \\ \{ \begin{matrix}{y}_{2} = h - 1 \\ {x}_{2} = - ( {B}_{v} * {y}_{2} + {C}_{v} ) / {A}_{v}\end{matrix}$$
wherein (x₁, y₁) and (x₂, y₂) are respectively the coordinates of the intersecting points, and w and h are respectively a width and a height of the hand image.

17. The non-volatile computer storage medium according to claim 14, wherein the instructions to calculate the main axis of the hand image cause the electronic device to:
traverse all pixels of the hand image, and save a coordinate of each obtained pixel in a matrix;
fit each element in the matrix by using the least square method to obtain a straight line; and
use the straight line obtained by fitting as the main axis.

18. An electronic device, comprising:
at least one processor; and
a memory communicably connected with the at least one processor for storing instructions executable by the at least one processor,
wherein execution of the instructions by the at least one processor causes the at least one processor to:
acquire a hand image, wherein the hand image comprises fingers, a wrist, and an arm;
calculate a dividing line that passes through a palm center location of the hand image and is perpendicular to a main axis of the hand image;
acquire respective relationships, between an area and a circumference, of two image areas formed by dividing the hand image by using the dividing line; and
determine the image areas in which the fingers and the wrist are respectively located, according to the relationships between the area and the circumference.

19. The electronic device according to claim 18, wherein the relationship between the area and the circumference is a ratio of the square of the circumference to the area, causes the at least one processor to:
determine the image areas in which the fingers and the wrist are respectively located, according to the relationships between the area and the circumference comprises:
compare respective ratios, of the two image areas, of the square of the circumference to the area; and
use an image area corresponding to a greater ratio as an image area in which the fingers are located, and use an image area corresponding to a less ratio as an image area in which the wrist is located.

20. The electronic device according to claim 18, wherein the execution of the instructions to calculate a dividing line that passes through a palm center location of the hand image and is perpendicular to a main axis of the hand image causes the at least one processor to:
calculate the palm center location of the hand image and the main axis of the hand image; and
calculate the dividing line according to the following formula:
Aᵥ=B
Bᵥ=−A
Cᵥ=A*yₚ−B*xₚ
wherein A, B, and C are linear equation parameters of the main axis, Aᵥ, Bᵥ, and Cᵥ are linear equation parameters of the dividing line, and (xₚ, yₚ) is a coordinate of the palm center location.

21. The electronic device according to claim 18, wherein the execution of the instructions to acquire respective relationships, between an area and a circumference, of two image areas formed by dividing the hand image by using the dividing line causes the at least one processor to:
acquire intersecting points of the dividing line and the hand image; and
obtaining the two image areas formed by dividing the hand image by using the dividing line, according to the acquired intersecting points and the dividing line.

22. The electronic device according to claim 21, wherein the execution of the instructions to acquire intersecting points of the dividing line and the hand image causes the at least one processor to:
detect an angle of the dividing line and a horizontal line; and
if the angle is less than 45 degrees, acquiring coordinates of the intersecting points of the dividing line and the hand image according to the following formula:
$$\{ \begin{matrix}{x}_{1} = 0 \\ {y}_{1} = - ( {A}_{v} * {x}_{1} + {C}_{v} ) / {B}_{v}\end{matrix} \\ \{ \begin{matrix}{x}_{2} = w - 1 \\ {y}_{2} = - ( {A}_{v} * {x}_{2} + {C}_{v} ) / {B}_{v}\end{matrix}$$
if the angle is greater than or equal to 45 degrees, acquire coordinates of the intersecting points of the dividing line and the hand image according to the following formula:
$$\{ \begin{matrix}{y}_{1} = 0 \\ {x}_{1} = - ( {B}_{v} * {y}_{1} + {C}_{v} ) / {A}_{v}\end{matrix} \\ \{ \begin{matrix}{y}_{2} = h - 1 \\ {x}_{2} = - ( {B}_{v} * {y}_{2} + {C}_{v} ) / {A}_{v}\end{matrix}$$
wherein (x₁, y₁) and (x₂, y₂) are respectively the coordinates of the intersecting points, and w and h are respectively a width and a height of the hand image.

23. The electronic device according to claim 20, wherein the execution of the instructions to calculate the main axis of the hand image causes the at least one processor to:
traverse all pixels of the hand image, and save a coordinate of each obtained pixel in a matrix;
fit each element in the matrix by using the least square method to obtain a straight line; and
use the straight line obtained by fitting as the main axis.

24. The electronic device according to claim 20, wherein the execution of the instructions to acquire a hand image causes the at least one processor to:
acquire a skin pixel model and a non-skin pixel model in advance;
traverse each pixel of an original image, and
match pixels obtained by traversing and, the skin pixel model and the non-skin pixel model that are acquired in advance;
obtain a skin area and a non-skin area by dividing according to match results; and
perform connected-area detection on the skin area to obtain the hand image.
